(19) United States
(12) Patent Application Publication
(10) Pub. No.: US 2011/0090216 A1
(43) Pub. Date: Apr. 21, 2011

(54) Pseudo 3D image creation apparatus and display system

(75) Inventors: Kunio Yamada, Kanagawa-ken (JP); Yasunari Suzuki, Kanagawa-ken (JP)

(73) Assignee: Victor Company of Japan, Ltd., Yokohama (JP)

(21) Appl. No.: 12/923,337

(22) Filed: Sep. 15, 2010

(30) Foreign Application Priority Data
Oct. 15, 2009 (JP) 2009-238026

(51) Int. Cl. G06T 15/00

(52) U.S. Cl. 345/419

(57) ABSTRACT

Basic depth models indicate depth values of a plurality of basic scene structures. Statistical amounts of pixel values in predetermined areas in a non-3D image are calculated to generate evaluation values. The basic depth models are combined into a combination result according to a combination ratio depending on the generated evaluation values. Calculation is made as to a skin-color intensity indicative of a degree of a skin color at each pixel of the non-3D image. Depth estimation data is generated from the combination result, the non-3D image, and the calculated skin-color intensity. A texture of the non-3D image is shifted in response to the generated depth estimation data to generate a different-viewpoint picture signal. The generated different-viewpoint picture signal and a picture signal representative of the non-3D image make a stereo pair representing a pseudo 3D image.

### BACKGROUND OF THE INVENTION

1. Field of the Invention

This invention relates to a pseudo 3D (three-dimensional) image creation apparatus and a pseudo 3D image display system.

2. Description of the Related Art

There are many ways to allow a non-3D image to be viewed as a 3D image in a 3D display system. In each of these ways, a pseudo 3D image is created from a regular still 2D image or moving 2D image, that is, a 2D image (a non-3D image) having depth information supplied neither explicitly nor, unlike a stereo image, implicitly.

U.S. Pat. No. 7,262,767 (corresponding to Japanese patent number 4214976) discloses a pseudo 3D image creation device designed to create a pseudo 3D image from a non-3D image.

The device of U.S. Pat. No. 7,262,767 calculates a high-frequency component value of a top part of the non-3D image, and a high-frequency component value of a bottom part thereof. The device includes frame memories storing three types of basic depth models indicating the depth values of three basic types of scene structures. A composition ratio is determined according to the calculated high-frequency component values. The three types of basic depth models are combined into fundamental depth data at the determined composition ratio. The R signal of the non-3D image is superimposed on the fundamental depth data to produce final depth data. The final depth data can be used in creating a pseudo 3D image from the non-3D image.

Regarding a non-3D image having a complicated pattern and a lot of edges, a pseudo 3D image created by the device of U.S. Pat. No. 7,262,767 tends to give a viewer a strong feeling of 3D. On the other hand, regarding a non-3D image having a simple pattern and few edges only, a pseudo 3D image created by the device of U.S. Pat. No. 7,262,767 tends to give a viewer a weak feeling of 3D. Generally, in the case of a non-3D image having a portion occupied by an image of a person, such a non-3D image portion has few edges only while other non-3D image portions have a complicated pattern and a lot of edges. Therefore, regarding the non-3D image portion occupied by the image of the person, a corresponding portion of a pseudo 3D image created by the device of U.S. Pat. No. 7,262,767 tends to give a viewer an insufficient feeling of 3D as compared to that given by other portions of the pseudo 3D image which originate from the non-3D image portions having the complicated pattern and the lot of edges. This is a problem since the image of the person is important to the viewer in most cases.

### SUMMARY OF THE INVENTION

It is a first object of this invention to provide a pseudo 3D image creation apparatus capable of creating, from a non-3D image, a pseudo 3D image in which an image portion occupied by an image of a person can give a viewer a sufficient feeling of 3D as other image portions having a complicated pattern and a lot of edges can.

It is a second object of this invention to provide a pseudo 3D image display system capable of creating a pseudo 3D image from a non-3D image and indicating the created pseudo 3D image in which an image portion occupied by an image of a person can give a viewer a sufficient feeling of 3D as other image portions having a complicated pattern and a lot of edges can.

A first aspect of this invention provides a pseudo 3D image creation apparatus comprising means for storing a plurality of basic depth models indicating depth values of a plurality of basic scene structures; means for calculating statistical amounts of pixel values in predetermined areas in a non-3D image to generate evaluation values, wherein the non-3D image has depth information supplied neither explicitly nor, unlike a stereo image, implicitly; means for combining said stored plurality of basic depth models into a combination result according to a combination ratio depending on the generated evaluation values; means for calculating a skin-color intensity indicative of a degree of a skin color at each pixel of the non-3D image; means for generating depth estimation data from said combination result, the non-3D image, and the calculated skin-color intensity; means for shifting a texture of the non-3D image in response to the generated depth estimation data to generate a different-viewpoint picture signal and to emphasize unevenness in a subject in the non-3D image on the basis of the calculated skin-color intensity; and means for outputting the generated different-viewpoint picture signal and a picture signal representative of the non-3D image as a pseudo 3D picture signal.

A second aspect of this invention provides a pseudo 3D image creation apparatus comprising means for storing a plurality of basic depth models indicating depth values of a plurality of basic scene structures; means for calculating statistical amounts of pixel values in predetermined areas in a non-3D image to generate evaluation values, wherein the non-3D image has depth information supplied neither explicitly nor, unlike a stereo image, implicitly; means for combining said stored plurality of basic depth models into a combination result according to a combination ratio depending on the generated evaluation values; means for calculating a skin-color intensity indicative of a degree of a skin color at each pixel of the non-3D image; means for generating depth estimation data from said combination result and the non-3D image; means for shifting a texture of the non-3D image in response to the generated depth estimation data to generate a first picture signal; means for implementing image emphasis on the generated first picture signal in response to the calculated skin-color intensity to generate a second picture signal, wherein a degree of the image emphasis on the generated first picture signal depends on the calculated skin-color intensity; and means for implementing image emphasis on a picture signal representative of the non-3D image in response to the calculated skin-color intensity to generate a third picture signal, wherein a degree of the image emphasis on the picture signal representative of the non-3D image depends on the calculated skin-color intensity, and the generated third picture signal forms a pseudo 3D picture signal in conjunction with the generated second picture signal.

A third aspect of this invention provides a pseudo 3D image display system comprising means for storing a plurality of basic depth models indicating depth values of a plurality of basic scene structures; means for calculating statistical amounts of pixel values in predetermined areas in a non-3D image to generate evaluation values, wherein the non-3D image has depth information supplied neither explicitly nor, unlike a stereo image, implicitly; means for combining said stored plurality of basic depth models into a combination result according to a combination ratio depending on the generated evaluation values; means for calculating a skin-color intensity indicative of a degree of a skin color at each pixel of the non-3D image; means for generating depth estimation data from said combination result, the non-3D image, and the calculated skin-color intensity; means for shifting a texture of the non-3D image in response to the generated depth estimation data to generate a different-viewpoint picture signal and to emphasize unevenness in a subject in the non-3D image on the basis of the calculated skin-color intensity; and means for using one of the generated different-viewpoint picture signal and a picture signal representative of the non-3D image as a right-eye picture signal and using the other as a left-eye picture signal, and indicating a pseudo 3D image in response to the right-eye picture signal and the left-eye picture signal.

A fourth aspect of this invention provides a pseudo 3D image display system comprising means for storing a plurality of basic depth models indicating depth values of a plurality of basic scene structures; means for calculating statistical amounts of pixel values in predetermined areas in a non-3D image to generate evaluation values, wherein the non-3D image has depth information supplied neither explicitly nor, unlike a stereo image, implicitly; means for combining said stored plurality of basic depth models into a combination result according to a combination ratio depending on the generated evaluation values; means for calculating a skin-color intensity indicative of a degree of a skin color at each pixel of the non-3D image; means for generating depth estimation data from said combination result and the non-3D image; means for shifting a texture of the non-3D image in response to the generated depth estimation data to generate a first picture signal; means for implementing image emphasis on the generated first picture signal in response to the calculated skin-color intensity to generate a second picture signal, wherein a degree of the image emphasis on the generated first picture signal depends on the calculated skin-color intensity; means for implementing image emphasis on a picture signal representative of the non-3D image in response to the calculated skin-color intensity to generate a third picture signal, wherein a degree of the image emphasis on the picture signal representative of the non-3D image depends on the calculated skin-color intensity; and means for using one of the generated second picture signal and the generated third picture signal as a right-eye picture signal and using the other as a left-eye picture signal, and indicating a pseudo 3D image in response to the right-eye picture signal and the left-eye picture signal.

A fifth aspect of this invention provides a pseudo 3D image creation apparatus comprising a memory configured to store a plurality of basic depth models indicating depth values of a plurality of basic scene structures; a calculator configured to calculate statistical amounts of pixel values in predetermined areas in a non-3D image to generate evaluation values, wherein the non-3D image has depth information supplied neither explicitly nor, unlike a stereo image, implicitly; a combiner configured to combine said stored plurality of basic depth models into a combination result according to a combination ratio depending on the generated evaluation values; a calculator configured to calculate a skin-color intensity indicative of a degree of a skin color at each pixel of the non-3D image; a generator configured to generate depth estimation data from said combination result, the non-3D image, and the calculated skin-color intensity; a shifter configured to shift a texture of the non-3D image in response to the generated depth estimation data to generate a different-viewpoint picture signal and to emphasize unevenness in a subject in the non-3D image on the basis of the calculated skin-color intensity; and an output device configured to output the generated different-viewpoint picture signal and a picture signal representative of the non-3D image as a pseudo 3D picture signal.

A sixth aspect of this invention provides a pseudo 3D image creation apparatus comprising a memory configured to store a plurality of basic depth models indicating depth values of a plurality of basic scene structures; a calculator configured to calculate statistical amounts of pixel values in predetermined areas in a non-3D image to generate evaluation values, wherein the non-3D image has depth information supplied neither explicitly nor, unlike a stereo image, implicitly; a combiner configured to combine said stored plurality of basic depth models into a combination result according to a combination ratio depending on the generated evaluation values; a calculator configured to calculate a skin-color intensity indicative of a degree of a skin color at each pixel of the non-3D image; a generator configured to generate depth estimation data from said combination result and the non-3D image; a shifter configured to shift a texture of the non-3D image in response to the generated depth estimation data to generate a first picture signal; an image enhancer configured to implement image emphasis on the generated first picture signal in response to the calculated skin-color intensity to generate a second picture signal, wherein a degree of the image emphasis on the generated first picture signal depends on the calculated skin-color intensity; and an image enhancer configured to implement image emphasis on a picture signal representative of the non-3D image in response to the calculated skin-color intensity to generate a third picture signal, wherein a degree of the image emphasis on the picture signal representative of the non-3D image depends on the calculated skin-color intensity, and the generated third picture signal forms a pseudo 3D picture signal in conjunction with the generated second picture signal.

A seventh aspect of this invention provides a pseudo 3D image creation apparatus comprising means for calculating a skin-color intensity at each pixel of a non-3D image represented by a first picture signal; and means for shifting a texture of the non-3D image relative to frame in response to the calculated skin-color intensity to convert the first picture signal into a second picture signal different in viewpoint from the first picture signal.

An eighth aspect of this invention is based on the seventh aspect thereof, and provides a pseudo 3D image creation apparatus further comprising means for using the first picture signal and the second picture signal as a stereo pair and visualizing the stereo pair to present a pseudo 3D image.

A ninth aspect of this invention provides a pseudo 3D image creation apparatus comprising means for calculating a skin-color intensity at each pixel of a non-3D image represented by a first picture signal; means for shifting a texture of the non-3D image relative to frame to generate a second picture signal different in viewpoint from the first picture signal; means for implementing image emphasis on the first picture signal in response to the calculated skin-color intensity to convert the first picture signal into a third picture signal, wherein a degree of the image emphasis on the first picture signal depends on the calculated skin-color intensity; and means for implementing image emphasis on the second picture signal in response to the calculated skin-color intensity to convert the second picture signal into a fourth picture signal different in viewpoint from the third picture signal.

A tenth aspect of this invention is based on the ninth aspect thereof, and provides a pseudo 3D image creation apparatus further comprising means for using the third picture signal and the fourth picture signal as a stereo pair and visualizing the stereo pair to present a pseudo 3D image.

This invention provides the following advantage. With respect to a pseudo 3D image originating from a non-3D image, the cubic effect attained for a portion of the non-3D image which is occupied by an image of a person can be comparable to that attained for other non-3D image portions having a complicated pattern and a lot of edges.

### BRIEF DESCRIPTION OF THE DRAWINGS

FIG. 1 is a block diagram of a pseudo 3D image creation apparatus according to a first embodiment of this invention.

FIG. 2 is a block diagram of a depth estimation data generator in FIG. 1.

FIG. 3 is a diagram showing a sigmoid function.

FIG. 4 is a diagram showing an example of the relation between an H value and a function value fh(H), and an example of the relation between an S×40 value and a function value fs(S×40) which are used by a skin-color-intensity evaluator in FIG. 2.

FIG. 5 is a block diagram of a depth model combiner in FIG. 2.

FIG. 6 is a block diagram of a stereo pair mate generator in FIG. 1.

FIG. 7 is a diagram showing an example of the relation among selected one or ones of signals of 1-frame pictures of basic depth model types A, B, and C, a top high-frequency component evaluation value, and a bottom high-frequency component evaluation value in the first embodiment of this invention.

FIG. 8 is a block diagram of a pseudo 3D image creation apparatus according to a second embodiment of this invention.

FIG. 9 is a block diagram of a depth estimation data generator in FIG. 8.

### DETAILED DESCRIPTION OF THE INVENTION

### First Embodiment

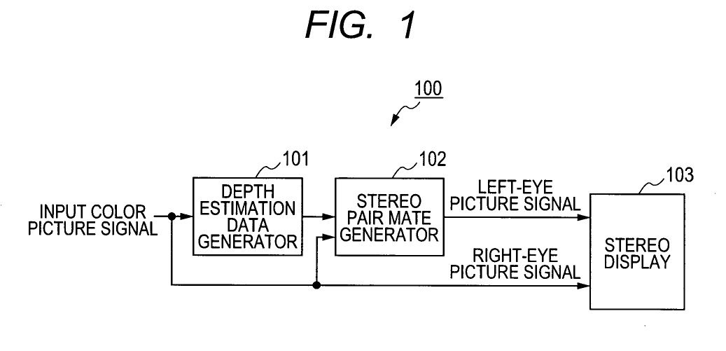

With reference to FIG. 1, a pseudo 3D (three-dimensional) image creation apparatus 100 in a first embodiment of this invention includes a depth estimation data generator 101 and a stereo pair mate generator 102.

The depth estimation data generator 101 receives an input color picture signal representing a non-3D image to be converted into a pseudo 3D image. The non-3D image has depth information supplied neither explicitly nor, unlike a stereo image, implicitly. The non-3D image is, for example, a repetitively-updated moving image or a still image. Generally, the input color picture signal is composed of three primary color signals (red, green, and blue signals shortened to R, G, and B signals). Preferably, the input color picture signal is formed by quantized picture data. The depth estimation data generator 101 produces final depth estimation data from the input color picture signal. The stereo pair mate generator 102 receives the final depth estimation data from the depth estimation data generator 101. The stereo pair mate generator 102 receives the input color picture signal also. The stereo pair mate generator 102 produces a left-eye picture signal (a different-viewpoint picture signal, that is, a picture signal different in viewpoint from the input color picture signal) from the final depth estimation data and the input color picture signal. The input color picture signal is used as a right-eye picture signal. The left-eye picture signal and the right-eye picture signal make a stereo pair.

A stereo display 103 receives the left-eye and right-eye picture signals and presents a pseudo 3D image to a viewer in response to the left-eye and right-eye picture signals. In other words, the left-eye and right-eye picture signals are outputted and fed to the stereo display 103 as a pseudo 3D picture signal. The stereo display 103 visualizes the pseudo 3D picture signal, and thereby indicates the pseudo 3D image.

The generation of the final depth estimation data by the depth estimation data generator 101 includes a step of detecting a part of the input color picture signal which represents a human-skin-colored portion of the non-3D image on a pixel-by-pixel basis, a step of emphasizing an amount of parallax for the human-skin-colored portion of the non-3D image relative to that for other portions thereof, and a step of using the emphasized parallax amount in determining the final depth estimation data.

The stereo pair mate generator 102 shifts the texture of the non-3D image represented by the input color picture signal relative to frame in response to the final depth estimation data. This shift means that with respect to on-screen position. Thereby, the stereo pair mate generator 102 converts the input color picture signal into a shift-result picture signal, that is, a picture signal different in viewpoint from the input color picture signal. The stereo pair mate generator 102 produces the left-eye picture signal from the shift-result picture signal.

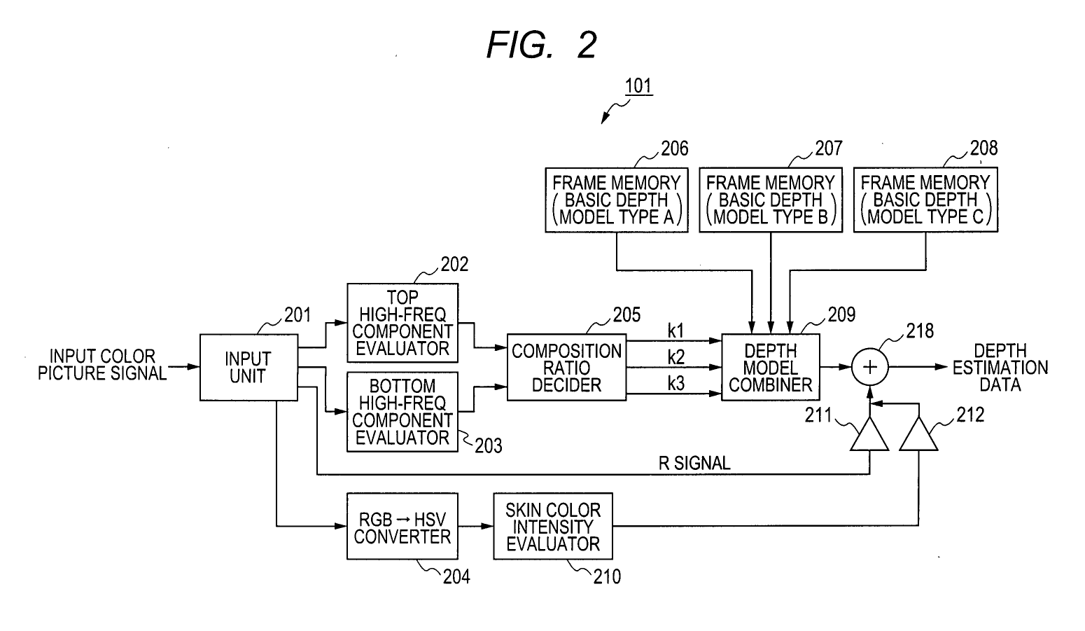

As shown in FIG. 2, the depth estimation data generator 101 includes an input unit 201, a top high-frequency component evaluator 202, a bottom high-frequency component evaluator 203, and an RGB-to-HSV converter 204.

The input unit 201 receives the input color picture signal and feeds the input color picture signal to the evaluators 202 and 203, and the converter 204. The top high-frequency component evaluator 202 calculates an evaluation value of high-spatial-frequency components of the input color picture signal for an about top 20% part of the non-3D image represented by the input color picture signal. The bottom high-frequency component evaluator 203 calculates an evaluation value of high-spatial-frequency components of the input color picture signal for an about bottom 20% part of the non-3D image represented by the input color picture signal. Preferably, the high-spatial-frequency components are of the luminance signal in the input color picture signal. The calculation by each of the evaluators 202 and 203 is equivalent to estimating an amount of the high-spatial-frequency components. The RGB-to-HSV converter 204 changes RGB color space data of the input color picture signal into corresponding HSV color space data.

The depth estimation data generator 101 further includes a composition ratio decider 205, frame memories 206, 207, and 208, a depth model combiner 209, a skin-color-intensity evaluator 210, weighters 211 and 212, and an adder 213.

The frame memory 206 stores a signal representative of a 1-frame picture of a basic depth model type A. The frame memory 206 feeds the stored signal to the depth model combiner 209. The frame memory 207 stores a signal representative of a 1-frame picture of a basic depth model type B differing from the type A. The frame memory 207 feeds the stored signal to the depth model combiner 209. The frame memory 208 stores a signal representative of a 1-frame picture of a basic depth model type C differing from the types A and B. The frame memory 208 feeds the stored signal to the depth model combiner 209. The composition ratio decider 205 is informed of the evaluation values calculated by the evaluators 202 and 203. The composition ratio decider 205 determines a composition ratio, at which the signals of the 1-frame pictures of the basic depth model types A, B, and C should be combined, on the basis of the evaluation values. The composition ratio decider 205 notifies the determined composition ratio to the depth model combiner 209. The depth model combiner 209 combines the signals of the 1-frame pictures of the basic depth model types A, B, and C into fundamental depth estimation data at a combination ratio equal to the notified composition ratio. The depth model combiner 209 feeds the fundamental depth estimation data to the adder 213. The input unit 201 extracts the R signal (the red signal) from the three primary color signals (the RGB signals) constituting the input color picture signal, and feeds the extracted R signal to the weighter 211. The weighter 211 multiplies the R signal by a predetermined weighting coefficient to generate a weighted R signal. The weighter 211 feeds the weighted R signal to the adder 213. The skin-color-intensity evaluator 210 receives the HSV color space data from the RGB-to-HSV converter 204. The skin-color-intensity evaluator 210 computes the intensity of human skin color at every pixel in the non-3D image from the H and S values represented by the corresponding 1-pixel segment of the HSV color space data. The skin-color-intensity evaluator 210 feeds the weighter 212 with a skin-color-intensity signal, that is, a signal representative of the computed human-skin-color intensities for the respective pixels constituting the non-3D image. The weighter 212 multiplies the skin-color-intensity signal by a predetermined weighting coefficient to generate a weighted skin-color-intensity signal. The weighter 212 feeds the weighted skin-color-intensity signal to the adder 213. The adder 213 superimposes the weighted R signal and the weighted skin-color-intensity signal on the fundamental depth estimation data to generate the final depth estimation data. The adder 213 outputs the final depth estimation data.

The RGB-to-HSV converter 204 and the skin-color-intensity evaluator 210 constitute skin-color-intensity calculating means. The composition ratio decider 205 and the depth model combiner 209 constitute combining means. The weighters 211 and 212, and the adder 213 constitute depth-estimation-data generating means.

The depth estimation data generator 101 is characterized in that the RGB-to-HSV converter 204, the skin-color-intensity evaluator 210, and the weighter 212 implement skin-color-based processing for emphasizing the cubic effect (the 3D effect) with respect to a part of the non-3D image which is occupied by an image of a person.

The RGB-to-HSV converter 204 receives the input color picture signal from the input unit 201, and changes RGB color space data of the input color picture signal into corresponding HSV color space data in a known way. The HSV color space is expressed by three elements, that is, hue, saturation, and value (or brightness) shortened to H, S, and V respectively. For every pixel in the non-3D image represented by the input color picture signal, the RGB-to-HSV converter 204 calculates the H value and the S value representative of hue and saturation in the HSV color space from the input color picture signal (the three primary color signals) in a known way. The RGB-to-HSV converter 204 notifies the calculated H and S values to the skin-color-intensity evaluator 210.

The skin-color-intensity evaluator 210 includes a memory storing a signal representing a predetermined function “fh” defining a relation between a hue coordinate value and an H value, and a signal representing a predetermined function “fs” defining a relation between a saturation coordinate value and an S value. For every pixel in the non-3D image represented by the input color picture signal, the skin-color-intensity evaluator 210 calculates the hue coordinate value from the notified H value by referring to the predetermined function “fh”. Similarly, the skin-color-intensity evaluator 210 calculates the saturation coordinate value from the notified S value by referring to the predetermined function “fs”. Then, the skin-color-intensity evaluator 210 computes the product of the calculated hue coordinate value and the calculated saturation coordinate value. For every pixel, the skin-color-intensity evaluator 210 labels the computed product as the computed intensity of human skin color at the pixel in the non-3D image. The predetermined function “fh” is applied to the H value variable in a range, the center of which is equal to 20. The predetermined function “fs” is applied to the S value multiplied by 40 where the multiplication result is variable in a range, the center of which is equal to 40. The multiplication by 40 is for normalization enabling the predetermined functions “fh” and “fs” to be the same.

The skin-color-intensity evaluator 210 decides that a limited H-S zone centered at about an H value of 20 and an S value of 0.5 (S×40=20) corresponds to a typical skin color. The skin-color-intensity evaluator 210 decides that an H-S zone with an H value closer to 0 or 40 has a less chance of corresponding to a skin color or a better chance of corresponding to a shaded skin color. Similarly, the skin-color-intensity evaluator 210 decides that an H-S zone with an S value closer to 0 (S×40=0) or 1 (S×40=40) has a less chance of corresponding to a skin color or a better chance of corresponding to a shaded skin color. Thereby, it is possible to estimate the unevenness in a skin-colored portion of the non-3D image.

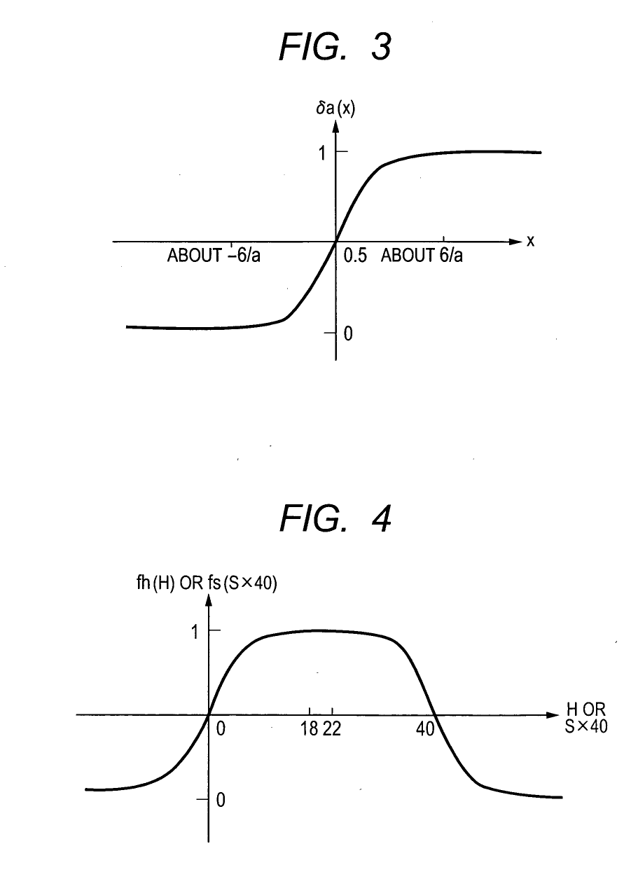

The predetermined functions “fh” and “fs” are made through the use of the sigmoid function δa(x)=1/(1+e^{-ax}). With reference to FIG. 3, the sigmoid function δa(x) is characterized in that the function value is very closer to 1 as an x value is greater than about 6/a. In view of this character of the sigmoid function δa(x), the predetermined function “fh” is designed so that the function value is 1 when the H value is between 18 and 22, and is 0 when the H value is 0 or 40. Similarly, the predetermined function “fs” is designed so that the function value is 1 when the S×40 value is between 18 and 22, and is 0 when the S×40 value is 0 or 40. Specifically, the predetermined functions “fh” and “fs” are expressed as follows.

$$\begin{matrix}\begin{matrix}0 ≦ H < 18 & fh ( H ) = ( \frac{1}{1 + {e}^{- \frac{1}{3} H}} - 0.5 ) \times 2\end{matrix} & ( 1 ) \\ \begin{matrix}18 ≦ H ≦ 22 & fh ( H ) = 1\end{matrix} & ( 2 ) \\ \begin{matrix}22 < H ≦ 40 & fh ( H ) = ( \frac{1}{1 + {e}^{\frac{1}{3} ( H - 40 )}} - 0.5 ) \times 2\end{matrix} & ( 3 ) \\ \begin{matrix}0 ≦ S \times 40 < 18 & fs ( S \times 40 ) = ( \frac{1}{1 + {e}^{- \frac{1}{3} ( S \times 40 )}} - 0.5 ) \times 2\end{matrix} & ( 4 ) \\ \begin{matrix}18 ≦ S \times 40 ≦ 22 & fs ( S \times 40 ) = 1\end{matrix} & ( 5 ) \\ \begin{matrix}22 < S \times 40 ≦ 40 & fs ( S \times 40 ) = ( \frac{1}{1 + {e}^{\frac{1}{3} ( S \times 40 - 40 )}} - 0.5 ) \times 2\end{matrix} & ( 6 )\end{matrix}$$

The predetermined functions “fh” and “fs” are shown in FIG. 4 where the ordinate denotes the function value fh(H) when the abscissa denotes the H value, and denotes the function value fs(S×40) when the abscissa denotes the S×40 value. The predetermined functions “fh” and “fs” are nonlinear. Regarding the predetermined function “fh”, the H value in the range between 18 and 22 corresponds to a typical skin-colored portion of the non-3D image. The H value equal to 0 or 40 corresponds to a typical non-skin-colored portion of the non-3D image. The H value in the range between 0 and 18 and the H value in the range between 22 and 40 correspond to image portions intermediate between the typical skin-colored image portion and the typical non-skin-colored image portion. Regarding the predetermined function “fs”, the S×40 value in the range between 18 and 22 corresponds to a typical skin-colored portion of the non-3D image. The S×40 value equal to 0 or 40 corresponds to a typical non-skin-colored portion of the non-3D image. The S×40 value in the range between 0 and 18 and the S×40 value in the range between 22 and 40 correspond to image portions intermediate between the typical skin-colored image portion and the typical non-skin-colored image portion.

The skin-color-intensity evaluator 210 is notified of the H value and the S value by the RGB-to-HSV converter 204. For every pixel, the skin-color-intensity evaluator 210 calculates the function value fh(H) from the H value by referring to the predetermined function “fh”. Similarly, the skin-color-intensity evaluator 210 calculates the function value fs(S×40) from the S value by referring to the predetermined function “fs”. Then, the skin-color-intensity evaluator 210 computes the product of the calculated function values fh(H) and fs(S×40). For every pixel, the skin-color-intensity evaluator 210 labels the computed product as the computed intensity of human skin color. The skin-color-intensity evaluator 210 feeds a signal representative of the computed human-skin-color intensity to the weighter 212.

Strictly speaking, human skin color depends on human race. The skin-color-intensity evaluator 210 is designed so that the computed human-skin-color intensity corresponds to a human-skin-colored portion of the non-3D image when the H value and the S×40 value are in prescribed ranges respectively. This design allows the computed human-skin-color intensity to reliably indicate whether or not every pixel is in a human-skin-colored portion of the non-3D image substantially independent of human race to which a subject person in the non-3D image belongs. Preferably, each of the above prescribed ranges of the H value and the S×40 value is between 18 and 22.

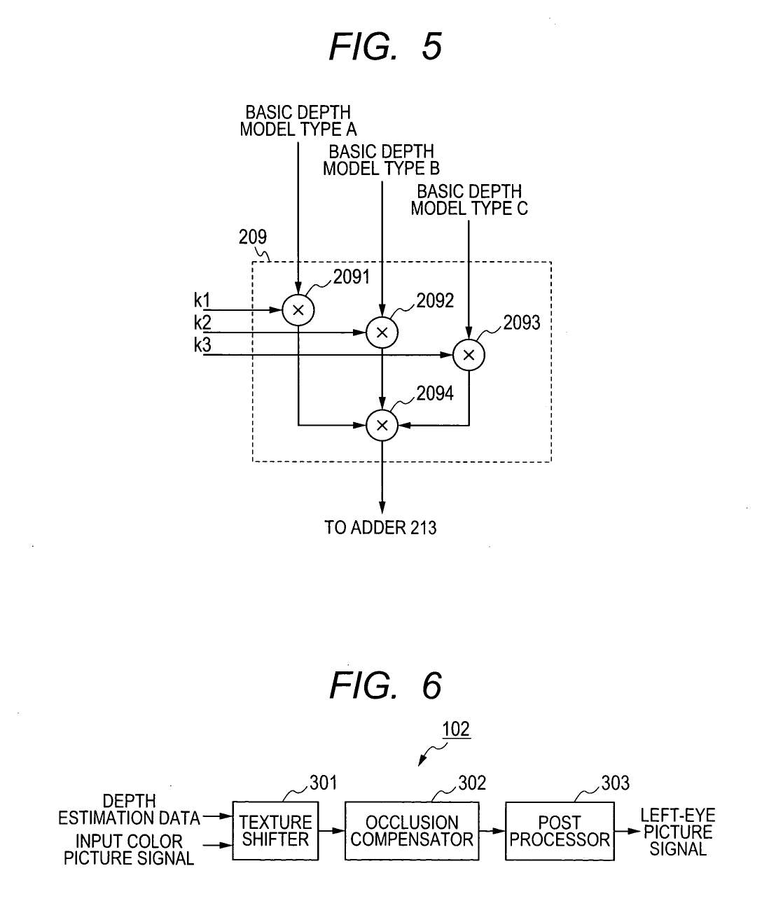

As shown in FIG. 5, the depth model combiner 209 includes multipliers 2091, 2092, and 2093, and an adder 2094. The composition ratio notified to the depth model combiner 209 from the composition ratio decider 205 is expressed by a set of coefficients k1, k2, and k3, where k1+k2+k3=1. As will be made clear later, the coefficients k1, k2, and k3 are assigned to the signals of the 1-frame pictures of the basic depth model types A, B, and C, respectively. The multipliers 2091, 2092, and 2093 are notified of the coefficients k1, k2, and k3, respectively. The multiplier 2091 receives the signal of the 1-frame picture of the basic depth model type A from the frame memory 206. The multiplier 2092 receives the signal of the 1-frame picture of the basic depth model type B from the frame memory 207. The multiplier 2093 receives the signal of the 1-frame picture of the basic depth model type C from the frame memory 208. The device 2091 multiplies the signal of the 1-frame picture of the basic depth model type A by the coefficient k1 to generate a multiplication-result type-A signal. The device 2092 multiplies the signal of the 1-frame picture of the basic depth model type B by the coefficient k2 to generate a multiplication-result type-B signal. The device 2093 multiplies the signal of the 1-frame picture of the basic depth model type C by the coefficient k3 to generate a multiplication-result type-C signal. The adder 2094 receives the multiplication-result type-A signal, the multiplication-result type-B signal, and the multiplication-result type-C signal from the multipliers 2091, 2092, and 2093. The device 2094 adds the multiplication-result type-A signal, the multiplication-result type-B signal, and the multiplication-result type-C signal to generate the fundamental depth estimation data. The adder 2094 outputs the fundamental depth estimation data to the adder 213 (see FIG. 2).

The basic depth model types A, B, and C are defined by depth values of basic scene structures. The basic depth model type A conforms to the concave surface of a sphere. The 1-frame picture of the basic depth model type A is used in many cases. The basic depth model type B is similar to the basic depth model type A except that its top part conforms to an arch-shaped cylindrical surface rather than a spherical surface. Thus, the top part of the basic depth model type B conforms to a cylindrical surface having an axis extending in a vertical direction, and the bottom part thereof conforms to a concave spherical surface. The top part of the basic depth model type C conforms to a flat surface, and the bottom part thereof conforms to a cylindrical surface having an axis extending in a horizontal direction. Regarding the basic depth model type C, the cylindrical surface continues from the flat surface and bends into a frontward direction as it gets near the bottom edge.

As shown in FIG. 6, the stereo pair mate generator 102 includes a texture shifter 301, an occlusion compensator 302, and a post processor 303 which are serially connected in that order. The occlusion compensator 302 and the post processor 303 constitute outputting means.

The texture shifter 301 receives the final depth estimation data from the depth estimation data generator 101. The texture shifter 301 receives the input color picture signal also. The device 301 shifts the non-3D image represented by the input color picture signal relative to frame in response to the final depth estimation data to generate a different-viewpoint image (an image seen from a viewpoint different from that for the non-3D image). In general, an object displayed in front of the screen is seen in the more inward side (nose side) of the viewer as the object is closer to the viewer. On the other hand, an object displayed behind the screen is seen in the more outward side of the viewer as the object is closer to the viewer. Accordingly, in the case of generating an image seen from a viewpoint shifted leftward from that for the non-3D image represented by the input color picture signal, the device 301 shifts a part of the texture of the non-3D image, which is to be displayed in front of the screen, to the inward (that is, the right) by an amount depending on the final depth estimation data. The device 301 shifts a part of the texture of the non-3D image, which is to be displayed behind the screen, to the outward (that is, the left) by an amount depending on the final depth estimation data. In this way, the texture shifter 301 converts the input color picture signal into a shift-result picture signal, that is, a different-viewpoint picture signal (a picture signal different in viewpoint from the input color picture signal). The texture shifter 301 feeds the shift-result picture signal to the occlusion compensator 302. The texture shifter 301 passes the input color picture signal to the occlusion compensator 302.

As a result of the shifting by the texture shifter 301, an image part where no texture is present, that is, an occlusion, is sometimes caused depending on an intra-image positional relation change. The occlusion compensator 302 fills such a part of the image represented by the shift-result picture signal with the corresponding part of the non-3D image represented by the input color picture signal, and thereby compensates for an occlusion in the image represented by the shift-result picture signal. Alternatively, the device 302 may implement occlusion compensation about the shift-result picture signal in a known way using the texture statistics of an image segmented. In this way, the occlusion compensator 302 converts the shift-result picture signal into an occlusion-free picture signal. The occlusion compensator 302 feeds the occlusion-free picture signal to the post processor 303.

The post processor 303 subjects the occlusion-free picture signal to known post processing such as smoothing to generate the left-eye picture signal. The post processor 303 outputs the left-eye picture signal. The post processing by the device 303 is to reduce noises in the occlusion-free picture signal which are caused by the previous-stage processing.

Operation of the pseudo 3D image creation apparatus 100 will be described below in more detail. The input unit 201 in the depth estimation data generator 101 receives the input color picture signal representing the non-3D image to be converted into the pseudo 3D image. As previously explained, the non-3D image is, for example, a repetitively-updated moving image or a still image. Generally, the input color picture signal is composed of three primary color signals (R, G, and B signals). Preferably, the input color picture signal is formed by the quantized picture data. The input unit 201 passes the input color picture signal to the top high-frequency component evaluator 202, the bottom high-frequency component evaluator 203, and the RGB-to-HSV converter 204. The input unit 201 extracts the R signal from the input color picture signal, and feeds the extracted R signal to the weighter 211.

The top high-frequency component evaluator 202 divides the about top 20% part of the non-3D image represented by the input color picture signal into blocks each composed of 8 pixels in the horizontal direction and 8 pixels in the vertical direction. The top high-frequency component evaluator 202 carries out calculation for each block by using the following equation.

$${\sum }_{i , j} ( \vert Y ( i , j ) - Y ( i + 2 , j ) \vert + \vert Y ( i , j ) - Y ( i , j + 2 ) \vert ) \qquad ( 7 )$$

where Y(i, j) denotes the luminance signal in the input color picture signal at the pixel point (i, j) in each block.

According to the equation (7), computations are made as to the absolute value of the difference between the luminance signal for the pixel of interest and the luminance signal for the pixel second next to the pixel of interest in the horizontal direction and the absolute value of the difference between the luminance signal for the pixel of interest and the luminance signal for the pixel second next to the pixel of interest in the vertical direction. Then, the computed absolute values are added to obtain an addition result. These computing steps are iterated while the pixel of interest is sequentially changed from one to another among all the pixels constituting the block. Consequently, addition results are obtained for the respective pixels constituting the block. Then, the addition results are summed to produce the intended value for the block.

The top high-frequency component evaluator 202 computes the average of the values produced by the above calculation for the blocks in the about top 20% part of the non-3D image. The top high-frequency component evaluator 202 labels the computed average as a top high-frequency component evaluation value. The top high-frequency component evaluator 202 notifies the top high-frequency component evaluation value to the composition ratio decider 205.

Similarly, the bottom high-frequency component evaluator 203 divides the about bottom 20% part of the non-3D image represented by the input color picture signal into blocks each composed of 8 pixels in the horizontal direction and 8 pixels in the vertical direction. The bottom high-frequency component evaluator 203 carries out calculation for each block by using the above equation (7). Then, the bottom high-frequency component evaluator 203 computes the average of the values produced by the above calculation for the blocks in the about bottom 20% part of the non-3D image. The bottom high-frequency component evaluator 203 labels the computed average as a bottom high-frequency component evaluation value. The bottom high-frequency component evaluator 203 notifies the bottom high-frequency component evaluation value to the composition ratio decider 205.

The composition ratio decider 205 determines the coefficients k1, k2, and k3 for the composition ratio on the basis of the top and bottom high-frequency component evaluation values.

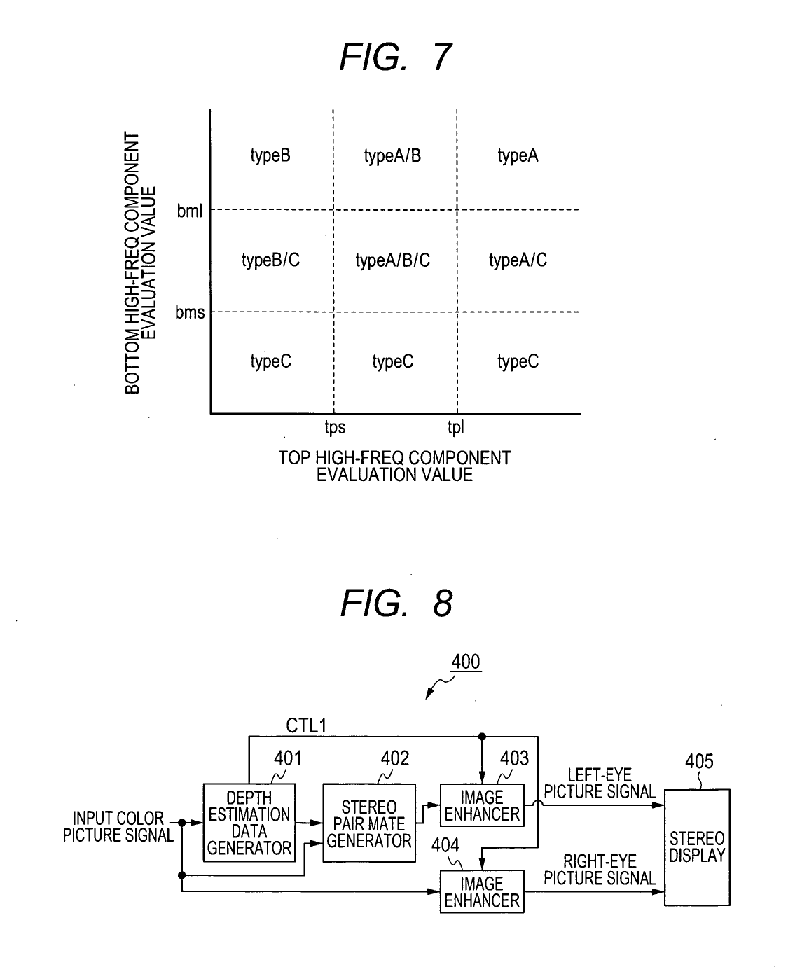

FIG. 7 shows an example of the relation among selected one or ones of the signals of the 1-frame pictures of the basic depth model types A, B, and C, the top high-frequency component evaluation value, and the bottom high-frequency component evaluation value. In FIG. 7, the ordinate denotes the bottom high-frequency component evaluation value while the abscissa denotes the top high-frequency component evaluation value.

With reference to FIG. 7, when the bottom high-frequency component evaluation value is smaller than a lower predesignated value “bms”, only the signal of the 1-frame picture of the basic depth model type C is selected independent of the top high-frequency component evaluation value (type C in FIG. 7). In this case, the composition ratio decider 205 sets the coefficients k1, k2, and k3 to 0, 0, and 1 respectively.

When the bottom high-frequency component evaluation value is greater than an upper predesignated value “bml” and the top high-frequency component evaluation value is smaller than a lower predesignated value “tps”, only the signal of the 1-frame picture of the basic depth model type B is selected (type B in FIG. 7). In this case, the composition ratio decider 205 sets the coefficients k1, k2, and k3 to 0, 1, and 0 respectively.

When the bottom high-frequency component evaluation value is greater than the upper predesignated value “bml” and the top high-frequency component evaluation value is greater than an upper predesignated value “tpl”, only the signal of the 1-frame picture of the basic depth model type A is selected (type A in FIG. 7). In this case, the composition ratio decider 205 sets the coefficients k1, k2, and k3 to 1, 0, and 0 respectively.

When the bottom high-frequency component evaluation value is greater than the upper predesignated value “bml” and the top high-frequency component evaluation value is between the lower predesignated value “tps” and the upper predesignated value “tpl”, only the signals of the 1-frame pictures of the basic depth model types A and B are selected (type A/B in FIG. 7). When the bottom high-frequency component evaluation value is between the lower predesignated value “bms” and the upper predesignated value “bml” and the top high-frequency component evaluation value is smaller than the lower predesignated value “tps”, only the signals of the 1-frame pictures of the basic depth model types B and C are selected (type B/C in FIG. 7). When the bottom high-frequency component evaluation value is between the lower predesignated value “bms” and the upper predesignated value “bml” and the top high-frequency component evaluation value is between the lower predesignated value “tps” and the upper predesignated value “tpl”, all the signals of the 1-frame pictures of the basic depth model types A, B, and C are selected (type A/B/C in FIG. 7). When the bottom high-frequency component evaluation value is between the lower predesignated value “bms” and the upper predesignated value “bml” and the top high-frequency component evaluation value is greater than the upper predesignated value “tpl”, only the signals of the 1-frame pictures of the basic depth model types A and C are selected (type A/C in FIG. 7).

In the regions “type A/B”, “type A/C”, “type B/C”, and “type A/B/C” of FIG. 7, the composition ratio decider 205 determines the coefficients k1, k2, and k3 for the composition ratio as follows.

In the region “type A/B”, the combination ratio between the signals of the 1-frame pictures of the basic depth model types A and B is determined by the ratio between “TA-tps” and “tpl-TA”, where TA denotes a top activity equal to the top high-frequency component evaluation value. In the region “type A/B”, only the signals of the 1-frame pictures of the basic depth model types A and B are used while the signal of the 1-frame picture of the basic depth model type C is not. Accordingly, the composition ratio is determined according to the following relation.

Type A:Type B:Type C=(TA−tps):(tpl−TA):0

In the region “type A/C”, the combination ratio between the signals of the 1-frame pictures of the basic depth model types A and C is determined by the ratio between “BA−bms” and “bml−BA”, where BA denotes a bottom activity equal to the bottom high-frequency component evaluation value. In the region “type A/C”, only the signals of the 1-frame pictures of the basic depth model types A and C are used while the signal of the 1-frame picture of the basic depth model type B is not. Accordingly, the composition ratio is determined according to the following relation.

Type A:Type B:Type C=(BA−bms):0:(bml−BA)

In the region “type B/C”, the combination ratio between the signals of the 1-frame pictures of the basic depth model types B and C is determined by the ratio between “BA−bms” and “bml−BA”. In the region “type B/C”, only the signals of the 1-frame pictures of the basic depth model types B and C are used while the signal of the 1-frame picture of the basic depth model type A is not. Accordingly, the composition ratio is determined according to the following relation.

Type A:Type B:Type C=0:(BA−bms):(bml−BA)

In the region “type A/B/C”, the average of the composition ratios for the regions “type A/B” and “type A/C” is used, and the final composition ratio is determined according to the following relation.

Type A:Type B:Type C=(TA−tps)+(BA−bms):(tpl−TA):(bml−BA)

In the regions “type A/B”, “type A/C”, “type B/C”, and “type A/B/C”, the coefficients k1, k2, and k3 for the composition ratio are given as follows.

k1=Type A/(Type A+Type B+Type C)

k2=Type B/(Type A+Type B+Type C)

k3=Type C/(Type A+Type B+Type C)

The depth model combiner 209 is notified of the coefficients k1, k2, and k3 determined by the composition ratio decider 205. The depth model combiner 209 receives the signals of the 1-frame pictures of the basic depth model types A, B, and C from the frame memories 206, 207, and 208. As previously explained, in the depth model combiner 209, the multiplier 2091 multiplies the signal of the 1-frame picture of the basic depth model type A by the coefficient k1 to generate a multiplication-result type-A signal. The multiplier 2092 multiplies the signal of the 1-frame picture of the basic depth model type B by the coefficient k2 to generate a multiplication-result type-B signal. The multiplier 2093 multiplies the signal of the 1-frame picture of the basic depth model type C by the coefficient k3 to generate a multiplication-result type-C signal. The adder 2094 adds the multiplication-result type-A signal, the multiplication-result type-B signal, and the multiplication-result type-C signal to generate the fundamental depth estimation data. The adder 2094 outputs the fundamental depth estimation data to the adder 213 (see FIG. 2).

As described above, the three types of basic depth models are prepared as depth structure models for basic scenes. The evaluation values of high-frequency components of the luminance signal in the input color picture signal are calculated for the top part and the bottom part of the non-3D image represented by the input color picture signal. Although the basic depth model A is used as the base, the composition ratio varies according to the scene. Specifically, when the top-part evaluation value is low, the ratio of the basic depth model B is increased to make the depth in the top part greater with the recognition that there is a sky or a flat wall in the top part. When the bottom-part evaluation value is low, the ratio of the basic depth model C is increased to make the top part flat as a distant view and to make the depth smaller as it gets near the lower edge of the bottom part with the recognition that there is a flat ground or a continuously-extending surface of the water in the bottom part. Therefore, any image can be displayed naturally and, at the same time, the scene structure can be determined as close to the real structure as possible.

With reference back to FIG. 2, the weighter 211 receives, from the input unit 201, the R signal in the input color picture signal. The weighter 211 multiplies the R signal by the predetermined weighting coefficient to generate the weighted R signal. The weighter 211 feeds the weighted R signal to the adder 213.

For every pixel in the non-3D image represented by the input color picture signal, the RGB-to-HSV converter 204 calculates the H value and the S value representative of hue and saturation in the HSV color space from the input color picture signal (the three primary color signals) in a known way. The RGB-to-HSV converter 204 notifies the calculated H and S values to the skin-color-intensity evaluator 210.

As previously mentioned, the skin-color-intensity evaluator 210 includes the memory storing the signals representing the predetermined functions “fh” and “fs” expressed by the equations (1)-(6). For every pixel in the non-3D image represented by the input color picture signal, the skin-color-intensity evaluator 210 calculates the function value fh(H) from the notified H value by referring to the predetermined function “fh”.

Similarly, the skin-color-intensity evaluator 210 calculates the function value fs(S×40) from the notified S value by referring to the predetermined function “fs”. Then, the skin-color-intensity evaluator 210 computes the product of the calculated function values fh(H) and fs(S×40). For every pixel, the skin-color-intensity evaluator 210 labels the computed product as the computed intensity of human skin color at the pixel in the non-3D image. The skin-color-intensity evaluator 210 feeds a signal representative of the computed human-skin-color intensity to the weighter 212.

The predetermined function “fh” is designed so that the function value fh(H) is given by the equation (2) and is equal to 1 when the H value is between 18 and 22. It is decided that a function value fh(H) of 1 has a good chance of corresponding to a pixel in a human-skin-colored portion of the non-3D image. Similarly, the predetermined function “fs” is designed so that the function value fs(S×40) is given by the equation (5) and is equal to 1 when the S×40 value is between 18 and 22. It is decided that a function value fs(S×40) of 1 has a good chance of corresponding to a pixel in a human-skin-colored portion of the non-3D image. The computed human-skin-color intensity is equal to the product of the function values fh(H) and fs(S×40). The skin-color-intensity evaluator 210 makes evaluations including the following conclusions. A computed human-skin-color intensity of 1 corresponds to a pixel of a human-skin-colored portion of the non-3D image. A computed human-skin-color intensity closer to 0 has a better chance of corresponding to a pixel outside a human-skin-colored portion of the non-3D image (a less chance of corresponding to a pixel in a human-skin-colored portion of the non-3D image or a better chance of corresponding to a pixel in a shaded human-skin-colored portion of the non-3D image).

As previously mentioned, the weighter 212 multiplies the skin-color-intensity signal by the predetermined weighting coefficient to generate the weighted skin-color-intensity signal. The weighter 212 feeds the weighted skin-color-intensity signal to the adder 213. The adder 213 superimposes the weighted R signal and the weighted skin-color-intensity signal on the fundamental depth estimation data to generate the final depth estimation data. The adder 213 outputs the final depth estimation data.

The skin-color-intensity evaluator 210, the weighter 212, and the adder 213 cooperate to generate the final depth estimation data in response to the skin-color-intensity signal. The generation of the final depth estimation data in response to the skin-color-intensity signal is designed so that an amount of parallax for a human-skin-colored portion of the non-3D image can be emphasized relative to that for other portions thereof.

One of the reasons for using the R signal is that in an environment almost equivalent to the front-light environment and under a condition where the texture brightness does not change largely, the rules of thumb show that the intensity of the R signal matches the concavity and convexity of the object in many cases. Another reason is that the red color and a warm color, called advancing colors in chromatics, are characterized in that they make the depth to be recognized closer to the front than a cold color. The attribute that makes the depth to be recognized closer to the front can enhance the cubic effect (the 3D effect).

While the red color and a warm color are advancing colors, the blue color is a receding color that makes the depth to be recognized in a more backward position than a warm color. Therefore, the cubic effect can also be enhanced by placing a blue part in the back. The cubic effect can also be enhanced by combining these two attributes, that is, by placing a red part in the front and a blue part in the back.

The computed human-skin-color intensity indicates the degree of agreement between the related pixel and a human-skin-colored portion of the non-3D image. As previously mentioned, the weighter 212 multiplies the skin-color-intensity signal by the predetermined weighting coefficient to generate the weighted skin-color-intensity signal. The weighted skin-color-intensity signal is used in generating the final depth estimation data. Thus, the cubic effect can be enhanced by emphasizing or increasing the unevenness of a part of a subject person in a human-skin-colored portion of a pseudo 3D image. Furthermore, the unevenness in a human-skin-colored portion of a pseudo 3D image can be properly emphasized.

The adder 213 in the depth estimation data generator 101 feeds the final depth estimation data to the stereo pair mate generator 102 (see FIGS. 1 and 6). The texture shifter 301 in the stereo pair mate generator 102 receives the final depth estimation data. The texture shifter 301 receives the input color picture signal also. The device 301 shifts the non-3D image represented by the input color picture signal relative to frame in response to the final depth estimation data to generate a different-viewpoint image (an image seen from a viewpoint different from that for the non-3D image).

Preferably, the final depth estimation data is divided into 8-bit segments assigned to the respective pixels or the respective unit blocks constituting the non-3D image represented by the input color picture signal. Every 8-bit segment of the final depth estimation data indicates a depth estimation value Yd. In ascending order of the depth estimation values Yd, that is, sequentially beginning with the one assigned to an image part positioned in the back, the texture shifter 301 shifts a part of the texture of the non-3D image represented by the input color picture signal, which corresponds to the depth estimation value Yd of interest, to the right by (Yd−m)/n pixels. Here, “m” denotes a vergence parameter or a reference depth, and a part of the image with Yd greater than “m” is displayed in front of the screen and a part of the image with Yd smaller than “m” is displayed in the back of the screen. In addition, “n” denotes a parameter for adjusting the cubic effect. When the value “(Yd−m)/n” is positive, the texture shift is rightward. When the value “(Yd−m)/n” is negative, the texture shift is leftward. When the value “(Yd−m)/n” is zero, no texture shift is performed. The vergence parameter (the reference depth) “m” is for adjusting the pop-up effect.

Thereby, the texture shifter 301 converts the input color picture signal into the shift-result picture signal. The occlusion compensator 302 which follows the texture shifter 301 implements occlusion compensation about the shift-result picture signal to generate an occlusion-free picture signal. The post processor 303 which follows the occlusion compensator 302 subjects the occlusion-free picture signal to the known post processing to generate the left-eye picture signal. The post processor 303 outputs the left-eye picture signal. As previously explained, the input color picture signal is used as the right-eye picture signal. The right-eye picture signal and the left-eye picture signal make a stereo pair. The right-eye and left-eye picture signals are fed to the stereo display 103. The stereo display 103 indicates a pseudo 3D image to a viewer in response to the right-eye and left-eye picture signals.

The stereo display 103 includes, for example, one of a projection system in which polarized glasses are used, a projection system or a display system in which a time-sharing-based indication technique and liquid-crystal shutter glasses are combined, a lenticular-mode stereo display, a parallax-barrier-based stereo display, an anaglyph-mode stereo display, and a head-mounted display. The stereo display 103 may include a projection system composed of two projectors corresponding to left-eye and right-eye images making a stereo pair respectively.

The depth estimation data generator 101 is designed so that an amount of parallax for a human-skin-colored portion of the non-3D image can be emphasized relative to that for other portions thereof. Accordingly, with respect to a pseudo 3D image originating from a non-3D image, the cubic effect attained for a portion of the non-3D image which is occupied by an image of a person can be comparable to that attained for other non-3D image portions having a complicated pattern and a lot of edges.

### Second Embodiment

With reference to FIG. 8, a pseudo 3D image creation apparatus 400 in a second embodiment of this invention includes a depth estimation data generator 401, a stereo pair mate generator 402, and image enhancers 403 and 404.

The depth estimation data generator 401 receives an input color picture signal representing a non-3D image to be converted into a pseudo 3D image. The depth estimation data generator 401 produces final depth estimation data and a control signal CTL1 from the input color picture signal. The stereo pair mate generator 402 receives the final depth estimation data from the depth estimation data generator 401. The stereo pair mate generator 402 receives the input color picture signal also. The stereo pair mate generator 402 produces a basic left-eye picture signal (a different-viewpoint picture signal, that is, a picture signal different in viewpoint from the input color picture signal) from the final depth estimation data and the input color picture signal. The input color picture signal is used as a basic right-eye picture signal. The basic left-eye picture signal and the basic right-eye picture signal make a basic stereo pair.

The image enhancer 403 receives the control signal CTL1 and the basic left-eye picture signal from the depth estimation data generator 401 and the stereo pair mate generator 402. The image enhancer 403 subjects the basic left-eye picture signal to image emphasis responsive to the control signal CTL1, and thereby converts the basic left-eye signal into a final left-eye picture signal. Specifically, the degree of the image emphasis depends on the control signal CTL1. The image enhancer 404 receives the control signal CTL1 from the depth estimation data generator 401. The image enhancer 404 receives the input color picture signal as the basic right-eye picture signal. The image enhancer 404 subjects the basic right-eye picture signal to image emphasis responsive to the control signal CTL1, and thereby converts the basic right-eye signal into a final right-eye picture signal. Specifically, the degree of the image emphasis depends on the control signal CTL1. The final left-eye picture signal and the final right-eye picture signal make a final stereo pair. The image enhancers 403 and 404 form first and second image emphasizing means.

A stereo display 405 receives the final left-eye and right-eye picture signals from the image enhancers 403 and 404, and presents a pseudo 3D image to a viewer in response to the final left-eye and right-eye picture signals. In other words, the final left-eye and right-eye picture signals are outputted and fed to the stereo display 405 as a pseudo 3D picture signal. The stereo display 405 visualizes the pseudo 3D picture signal, and thereby indicates the pseudo 3D image. The stereo display 405 is the same in structure as the stereo display 103 in FIG. 1.

The pseudo 3D image creation apparatus 400 is modified from the pseudo 3D image creation apparatus 100 of FIG. 1 in the following points. The depth estimation data generator 401 is similar to the depth estimation data generator 101 (see FIG. 2) except for design changes mentioned hereafter. The image enhancers 403 and 404 are added as compared to the structure of the pseudo 3D image creation apparatus 100. The stereo pair mate generator 402 is the same in structure as the stereo pair mate generator 102 of FIG. 6.

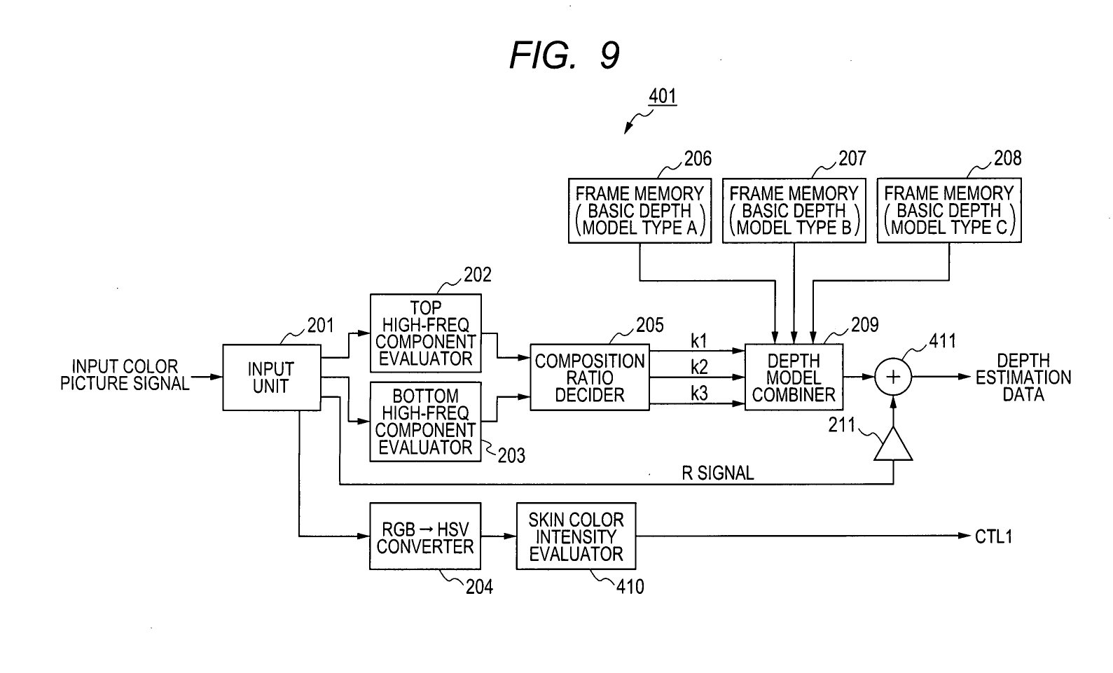

As shown in FIG. 9, the depth estimation data generator 401 includes a skin-color-intensity evaluator 410 and an adder 411 which replace the skin-color-intensity evaluator 210 and the adder 213 (see FIG. 2) respectively. The RGB-to-HSV converter 204 notifies the calculated H and S values to the skin-color-intensity evaluator 410.

The skin-color-intensity evaluator 410 includes a memory storing signals representing the predetermined functions “fh” and “fs” expressed by the equations (1)-(6). For every pixel in the non-3D image represented by the input color picture signal, the skin-color-intensity evaluator 410 calculates the function value fh(H) from the notified H value by referring to the predetermined function “fh”. Similarly, the skin-color-intensity evaluator 410 calculates the function value fs(S×40) from the notified S value by referring to the predetermined function “fs”. Then, the skin-color-intensity evaluator 410 computes the product of the calculated function values fh(H) and fs(S×40). For every pixel, the skin-color-intensity evaluator 410 labels the computed product as the computed intensity of human skin color at the pixel in the non-3D image. The skin-color-intensity evaluator 410 outputs a signal representative of the computed human-skin-color intensity as the control signal CTL1. The skin-color-intensity evaluator 410 feeds the control signal CTL1 to the image enhancers 403 and 404 (see FIG. 8). The RGB-to-HSV converter 204 and the skin-color-intensity evaluator 410 constitute skin-color-intensity calculating means.

The adder 411 receives the fundamental depth estimation data from the depth model combiner 209. The adder 411 receives the weighted R signal from the weighter 211. The adder 411 superimposes the weighted R signal on the fundamental depth estimation data to generate final depth estimation data. The adder 411 outputs the final depth estimation data to the stereo pair mate generator 402 (see FIG. 8).

The stereo pair mate generator 402 receives the input color picture signal. The stereo pair mate generator 402 shifts the non-3D image represented by the input color picture signal relative to frame in response to the final depth estimation data to generate a shift-result picture signal, that is, a different-viewpoint picture signal. The stereo pair mate generator 402 implements occlusion compensation about the shift-result picture signal to generate an occlusion-free picture signal. The stereo pair mate generator 402 subjects the occlusion-free picture signal to known post processing to generate the basic left-eye picture signal. The stereo pair mate generator 402 outputs the left-eye picture signal to the image enhancer 403.

The image enhancer 403 receives the control signal CTL1 from the depth estimation data generator 401. The image enhancer 403 subjects the basic left-eye picture signal to image emphasis responsive to the control signal CTL1, and thereby converts the basic left-eye signal into a final left-eye picture signal. Specifically, the image enhancer 403 controls the degree of image emphasis on the basic left-eye picture signal in response to the control signal CTL1, that is, the computed human-skin-color intensity to generate the final left-eye picture signal. The image enhancer 404 receives the control signal CTL1 from the depth estimation data generator 401. The image enhancer 404 receives the input color picture signal as the basic right-eye picture signal. The image enhancer 404 subjects the basic right-eye picture signal to image emphasis responsive to the control signal CTL1, and thereby converts the basic right-eye signal into a final right-eye picture signal. Specifically, the image enhancer 404 controls the degree of image emphasis on the basic right-eye picture signal in response to the control signal CTL1, that is, the computed human-skin-color intensity to generate the final right-eye picture signal. The final left-eye picture signal and the final right-eye picture signal make a final stereo pair. The final left-eye picture signal and the final right-eye picture signal are outputted from the image enhancers 403 and 404 to the stereo display 405.

Each of the image emphases implemented by the image enhancers 403 and 404 includes at least one of emphasis on high-frequency signal components, contrast adjustment, luminance modulation, and chroma emphasis. Preferably, each of the image emphases by the image enhancers 403 and 404 is designed so that stronger emphasis will be performed on the shading and the details of images of a face and a skin which extend in an image part of interest and stronger chroma correction will be performed on the face and skin images than those on an image part different from the image part of interest. In this case, a viewer can perceive greater unevenness in the image part of the interest than that in the other image part.

The pseudo 3D image creation apparatus 400 is designed so that image emphasis will be performed on a human-skin-colored portion of the non-3D image. Accordingly, with respect to a pseudo 3D image originating from a non-3D image, the cubic effect attained for a portion of the non-3D image which is occupied by an image of a person can be comparable to that attained for other non-3D image portions having a complicated pattern and a lot of edges.

### Third Embodiment

According to a third embodiment of this invention, the pseudo 3D image creation apparatuses 100 and 400 except the stereo displays 103 and 405 are combined.

### Fourth Embodiment

A fourth embodiment of this invention is similar to the first or second embodiment thereof except for the following design change. In the fourth embodiment of this invention, predetermined functions “fh” and “fs” provide function values which can assume one of 0 and 1 only. Specifically, the predetermined function “fh” is designed so that the function value fh(H) is 1 when the H value is between 18 and 22, and is 0 when the H value is outside the range between 18 and 22. Similarly, the predetermined function “fs” is designed so that the function value fs(S×40) is 1 when the S×40 value is between 18 and 22, and is 0 when the S×40 value is outside the range between 18 and 22.

### Fifth Embodiment

A fifth embodiment of this invention is similar to the first or second embodiment thereof except for a design change described hereafter. The final depth estimation data is generated on the basis of the evaluation values calculated by the top high-frequency component evaluator 202 and the bottom high-frequency component evaluator 203. The texture shift amount depends on the depth estimation value Yd indicated by the final depth estimation data. In the fifth embodiment of this invention, the control of the texture shift amount in response to the high-frequency component evaluation values are designed as follows. According to a first example, the high-frequency component evaluation values are added to or subtracted from a basic desired texture shift amount to obtain a final desired texture shift amount by which an actual texture shift is implemented. According to a second example, the vergence parameter “m” is varied as a function of the high-frequency component evaluation values. In this case, the pop-up effect is controlled depending on the high-frequency component evaluation values. According to a third example, the weighting coefficient used in the weighter 211 is varied as a function of the high-frequency component evaluation values.

### Sixth Embodiment

A sixth embodiment of this invention is similar to the first or second embodiment thereof except for a design change described hereafter. The final depth estimation data is generated on the basis of the computed human-skin-color intensity generated by the skin-color-intensity evaluator 210 or 410. The texture shift amount depends on the depth estimation value Yd indicated by the final depth estimation data. In the sixth embodiment of this invention, the control of the texture shift amount in response to the computed human-skin-color intensity is designed as follows. According to a first example, the computed human-skin-color intensity is added to or subtracted from a basic desired texture shift amount to obtain a final desired texture shift amount by which an actual texture shift is implemented. According to a second example, the vergence parameter “m” is varied as a function of the computed human-skin-color intensity. In this case, the pop-up effect is controlled depending on the computed human-skin-color intensity. According to a third example, the weighting coefficient used in the weighter 211 is varied as a function of the computed human-skin-color intensity.

### Seventh Embodiment

A seventh embodiment of this invention is similar to the first or second embodiment thereof except for a design change described hereafter. In the seventh embodiment of this invention, the input color picture signal is used as a left-eye picture signal while the picture signal outputted from the stereo pair mate generator 102 or 402 is used as a right-eye picture signal making a stereo pair in conjunction with the left-eye picture signal. A first different-viewpoint picture signal and a second different-viewpoint picture signal may be generated through rightward viewpoint shift and leftward viewpoint shift of the non-3D image represented by the input color picture signal, respectively. In this case, the first and second different-viewpoint picture signals make a stereo pair.

### Eighth Embodiment

An eighth embodiment of this invention is similar to the first or second embodiment thereof except for a design change described hereafter. In the eighth embodiment of this invention, three or more different-viewpoint picture signals are generated. The stereo display 103 or 405 is replaced by a three-viewpoint or more-viewpoint display for indicating a pseudo 3D image from the three or more different-viewpoint picture signals.

### Ninth Embodiment

A ninth embodiment of this invention is similar to the first or second embodiment thereof except for a design change described hereafter. In the ninth embodiment of this invention, an audio output device is provided. For example, the audio output device is installed in the stereo display 103 or 405. In this case, for a video content with no audio information such as a still image, an ambient sound suitable for the video content may be added.

### Tenth Embodiment

A tenth embodiment of this invention is similar to the first or second embodiment thereof except for a design change described hereafter. In the ninth embodiment of this invention, a computer system replaces the combination of the depth estimation data generator 101 and the stereo pair mate generator 102 or the combination of the depth estimation data generator 401, the stereo pair mate generator 402, and the image enhancers 403 and 404. The computer system is controlled by a computer program installed therein. The computer program is designed to enable the computer system to implement operation steps equivalent to the functions of the depth estimation data generator 101 and the stereo pair mate generator 102 or the functions of the depth estimation data generator 401, the stereo pair mate generator 402, and the image enhancers 403 and 404. The computer program can be read from a recording medium into the computer system or may be downloaded into the computer system via a network.

What is claimed is:

1. A pseudo 3D image creation apparatus comprising:
means for storing a plurality of basic depth models indicating depth values of a plurality of basic scene structures;
means for calculating statistical amounts of pixel values in predetermined areas in a non-3D image to generate evaluation values, wherein the non-3D image has depth information supplied neither explicitly nor, unlike a stereo image, implicitly;
means for combining said stored plurality of basic depth models into a combination result according to a combination ratio depending on the generated evaluation values;
means for calculating a skin-color intensity indicative of a degree of a skin color at each pixel of the non-3D image;
means for generating depth estimation data from said combination result, the non-3D image, and the calculated skin-color intensity;
means for shifting a texture of the non-3D image in response to the generated depth estimation data to generate a different-viewpoint picture signal and to emphasize unevenness in a subject in the non-3D image on the basis of the calculated skin-color intensity; and
means for outputting the generated different-viewpoint picture signal and a picture signal representative of the non-3D image as a pseudo 3D picture signal.

2. A pseudo 3D image creation apparatus comprising:
means for storing a plurality of basic depth models indicating depth values of a plurality of basic scene structures;
means for calculating statistical amounts of pixel values in predetermined areas in a non-3D image to generate evaluation values, wherein the non-3D image has depth information supplied neither explicitly nor, unlike a stereo image, implicitly;
means for combining said stored plurality of basic depth models into a combination result according to a combination ratio depending on the generated evaluation values;
means for calculating a skin-color intensity indicative of a degree of a skin color at each pixel of the non-3D image;
means for generating depth estimation data from said combination result and the non-3D image;
means for shifting a texture of the non-3D image in response to the generated depth estimation data to generate a first picture signal;
means for implementing image emphasis on the generated first picture signal in response to the calculated skin-color intensity to generate a second picture signal, wherein a degree of the image emphasis on the generated first picture signal depends on the calculated skin-color intensity; and
means for implementing image emphasis on a picture signal representative of the non-3D image in response to the calculated skin-color intensity to generate a third picture signal, wherein a degree of the image emphasis on the picture signal representative of the non-3D image depends on the calculated skin-color intensity, and the generated third picture signal forms a pseudo 3D picture signal in conjunction with the generated second picture signal.

3. A pseudo 3D image display system comprising:
means for storing a plurality of basic depth models indicating depth values of a plurality of basic scene structures;
means for calculating statistical amounts of pixel values in predetermined areas in a non-3D image to generate evaluation values, wherein the non-3D image has depth information supplied neither explicitly nor, unlike a stereo image, implicitly;
means for combining said stored plurality of basic depth models into a combination result according to a combination ratio depending on the generated evaluation values;
means for calculating a skin-color intensity indicative of a degree of a skin color at each pixel of the non-3D image;
means for generating depth estimation data from said combination result, the non-3D image, and the calculated skin-color intensity;
means for shifting a texture of the non-3D image in response to the generated depth estimation data to generate a different-viewpoint picture signal and to emphasize unevenness in a subject in the non-3D image on the basis of the calculated skin-color intensity; and
means for using one of the generated different-viewpoint picture signal and a picture signal representative of the non-3D image as a right-eye picture signal and using the other as a left-eye picture signal, and indicating a pseudo 3D image in response to the right-eye picture signal and the left-eye picture signal.

4. A pseudo 3D image display system comprising:
means for storing a plurality of basic depth models indicating depth values of a plurality of basic scene structures;
means for calculating statistical amounts of pixel values in predetermined areas in a non-3D image to generate evaluation values, wherein the non-3D image has depth information supplied neither explicitly nor, unlike a stereo image, implicitly;
means for combining said stored plurality of basic depth models into a combination result according to a combination ratio depending on the generated evaluation values;
means for calculating a skin-color intensity indicative of a degree of a skin color at each pixel of the non-3D image;
means for generating depth estimation data from said combination result and the non-3D image;
means for shifting a texture of the non-3D image in response to the generated depth estimation data to generate a first picture signal;
means for implementing image emphasis on the generated first picture signal in response to the calculated skin-color intensity to generate a second picture signal, wherein a degree of the image emphasis on the generated first picture signal depends on the calculated skin-color intensity;
means for implementing image emphasis on a picture signal representative of the non-3D image in response to the calculated skin-color intensity to generate a third picture signal, wherein a degree of the image emphasis on the picture signal representative of the non-3D image depends on the calculated skin-color intensity; and
means for using one of the generated second picture signal and the generated third picture signal as a right-eye picture signal and using the other as a left-eye picture signal, and indicating a pseudo 3D image in response to the right-eye picture signal and the left-eye picture signal.

5. A pseudo 3D image creation apparatus comprising:
a memory configured to store a plurality of basic depth models indicating depth values of a plurality of basic scene structures;
a calculator configured to calculate statistical amounts of pixel values in predetermined areas in a non-3D image to generate evaluation values, wherein the non-3D image has depth information supplied neither explicitly nor, unlike a stereo image, implicitly;
a combiner configured to combine said stored plurality of basic depth models into a combination result according to a combination ratio depending on the generated evaluation values;
a calculator configured to calculate a skin-color intensity indicative of a degree of a skin color at each pixel of the non-3D image;
a generator configured to generate depth estimation data from said combination result, the non-3D image, and the calculated skin-color intensity;
a shifter configured to shift a texture of the non-3D image in response to the generated depth estimation data to generate a different-viewpoint picture signal and to emphasize unevenness in a subject in the non-3D image on the basis of the calculated skin-color intensity; and
an output device configured to output the generated different-viewpoint picture signal and a picture signal representative of the non-3D image as a pseudo 3D picture signal.

6. A pseudo 3D image creation apparatus comprising:
a memory configured to store a plurality of basic depth models indicating depth values of a plurality of basic scene structures;
a calculator configured to calculate statistical amounts of pixel values in predetermined areas in a non-3D image to generate evaluation values, wherein the non-3D image has depth information supplied neither explicitly nor, unlike a stereo image, implicitly;
a combiner configured to combine said stored plurality of basic depth models into a combination result according to a combination ratio depending on the generated evaluation values;
a calculator configured to calculate a skin-color intensity indicative of a degree of a skin color at each pixel of the non-3D image;
a generator configured to generate depth estimation data from said combination result and the non-3D image;
a shifter configured to shift a texture of the non-3D image in response to the generated depth estimation data to generate a first picture signal;
an image enhancer configured to implement image emphasis on the generated first picture signal in response to the calculated skin-color intensity to generate a second picture signal, wherein a degree of the image emphasis on the generated first picture signal depends on the calculated skin-color intensity; and
an image enhancer configured to implement image emphasis on a picture signal representative of the non-3D image in response to the calculated skin-color intensity to generate a third picture signal, wherein a degree of the image emphasis on the picture signal representative of the non-3D image depends on the calculated skin-color intensity, and the generated third picture signal forms a pseudo 3D picture signal in conjunction with the generated second picture signal.

7. A pseudo 3D image creation apparatus comprising:
means for calculating a skin-color intensity at each pixel of a non-3D image represented by a first picture signal; and
means for shifting a texture of the non-3D image relative to frame in response to the calculated skin-color intensity to convert the first picture signal into a second picture signal different in viewpoint from the first picture signal.

8. A pseudo 3D image creation apparatus as recited in claim 7, further comprising means for using the first picture signal and the second picture signal as a stereo pair and visualizing the stereo pair to present a pseudo 3D image.

9. A pseudo 3D image creation apparatus comprising:
means for calculating a skin-color intensity at each pixel of a non-3D image represented by a first picture signal;
means for shifting a texture of the non-3D image relative to frame to generate a second picture signal different in viewpoint from the first picture signal;
means for implementing image emphasis on the first picture signal in response to the calculated skin-color intensity to convert the first picture signal into a third picture signal, wherein a degree of the image emphasis on the first picture signal depends on the calculated skin-color intensity; and
means for implementing image emphasis on the second picture signal in response to the calculated skin-color intensity to convert the second picture signal into a fourth picture signal different in viewpoint from the third picture signal.

10. A pseudo 3D image creation apparatus as recited in claim 9, further comprising means for using the third picture signal and the fourth picture signal as a stereo pair and visualizing the stereo pair to present a pseudo 3D image.
